(19) United States
(12) Patent Application Publication
(10) Pub. No.: US 2018/0151020 A1
(43) Pub. Date: May 31, 2018

(54) AUTOMATIC FILM MERCHANDISER

(71) Applicant: Terrence Fountain, Hubert, NC (US)

(72) Inventor: Terrence Fountain, Hubert, NC (US)

(21) Appl. No.: 15/824,768

(22) Filed: Nov. 28, 2017

Related U.S. Application Data
(60) Provisional application No. 62/426,862, filed on Nov. 28, 2016.

(51) Int. Cl. G07F 11/70; G07F 11/00; G07F 11/68; G07F 9/02; G07F 9/00; G07F 7/08; G06T 17/00; B29D 11/00; B29D 7/01; B32B 7/06; B26D 7/27; B44C 1/165

(52) U.S. Cl. CPC G07F 11/70; B32B 2307/42; G07F 11/68; G07F 9/026; G07F 9/006; G07F 7/08; G06T 17/00; B29D 11/0073; B29D 7/01; B32B 7/06; B26D 7/27; B44C 1/165; B32B 2405/00; B32B 2307/402; B32B 2307/41; G07F 11/007

(57) ABSTRACT

An automatic merchandising system that can create and vend tinted films, stickers, and decals from a product placed in and scanned by the system. A user can choose specific designs from a menu of designs. The automatic merchandising system can be connected to the internet enabling a user to download content to be turned into stickers or decals. The automatic merchandising system may also include image editing software to turn photographs and digital images into a high contrast image that can be cut into a sticker.

### CROSS-REFERENCE TO RELATED APPLICATION

The present application is related to and claims priority from provisional application Ser. No. 62/426,862, filed Nov. 28, 2016, which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates to an automatic merchandising system, wherein the automatic merchandising system is a system that vends tinted films, stickers, and decals. Herein the at least one user is enabled to choose the designs for each product category from the menu of the designs available. The automatic merchandising system is also connected to the internet enabling the at least one user to download content to be turned into stickers or decals and potentially the automatic merchandising system may also have a image editing software enabling the at least one user to turn a photo or other digital image into a high contrast image that is to be cut into a sticker.

### 2. Description of the Related Art

The most commonly known machine for executing the at least one user request immediately on his/her command is the ATM machine, wherein a ATM machine is an electronic telecommunications device that enables the customers of a financial institution to perform financial transactions, particularly cash withdrawal, without the need for a human cashier, clerk or bank teller. But still there don't exist a machine which can act as an automatic merchandiser and which can process the request for any items or goods according to the at least one user's need. Also, the various merchandising machines available in the market are not enabled with the feature to choose the designs for each product category from the menu of the designs available and connect to the internet enabling the at least one user to download content to be turned into stickers or decals and neither have the potential to have image editing software enabling the at least one user to turn a photo or other digital image into a high contrast image that is to be cut into a sticker.

### BRIEF SUMMARY OF THE INVENTION

In view of the foregoing disadvantages inherent in the known automatic merchandising systems, the present invention provides an automatic merchandising system that vends tinted films, stickers, and decals. Herein the at least one user is enabled to choose the designs for each product category from the menu of the designs available. The automatic merchandising system is also connected to the internet enabling the at least one user to download content to be turned into stickers or decals and potentially the automatic merchandising system and also have image editing software enabling users to turn a photo or other digital image into a high contrast image that is to be cut into a sticker.

In a situation that a user has a pair of eyeglasses that he/she desires to convert into sunglasses then he/she goes to the automatic merchandiser system, which is contained within a free-standing cabinet. The display on the screen of the automatic merchandiser system shows examples of products or promotional art until interacted by the at least one user. The at least one user is then directed to select an option from the menu for the purchase of an item for example; a lens covers. The at least one user herein is then enabled to choose a material from a variety of materials to select the type and quality of lens cover the at least one user wants. Then the at least one user is prompted to pay for his/her selected option. The scanning bay of the automatic merchandiser system is unlocked and the user is prompted to place his/her glasses to be outfitted with the lens covers on the marker in the scanner and close the compartment, the machine scans the glasses to determine the dimensions to cut from the material selected. The machine cuts the material from a spool of stocked material by use of a plotter, which is fed the dimensions from the scan performed. The custom cut material is dropped into the delivery box and the at least one user is prompted to take their glasses and the custom cut lens covers. A receipt is then printed. Instructions on how to apply the product is also provided by printed material or on screen.

Certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, automatic merchandising system constructed and operative according to the teachings of the present invention.

FIG. 1 shows a perspective view illustrating a preferred embodiment of the automatic merchandiser system.

FIG. 2 is a perspective view illustrating the scanner drawer of the preferred embodiment of the automatic merchandiser system of FIG. 1.

FIG. 3 is a second perspective view illustrating the scanner drawer of the preferred embodiment of the automatic merchandiser system of FIG. 1.

FIG. 4 is a perspective view illustrating one spool of stocked material and a respective cutting member of the preferred embodiment of the automatic merchandiser system of FIG. 1.

FIG. 5 is a perspective view illustrating three spools of stocked material and three respective cutting members of the preferred embodiment of the automatic merchandiser system of FIG. 1.

FIG. 6 is a second perspective view illustrating the product receiving compartment of the preferred embodiment of the automatic merchandiser system of FIG. 1.

FIG. 7 is a second perspective view illustrating the protective film including adhesive material and a removable backing material of the preferred embodiment of the automatic merchandiser system of FIG. 1.

The various embodiments of the present invention will hereinafter be described in conjunction with the appended drawings, wherein like designations denote like elements.

### DETAILED DESCRIPTION

As discussed above, embodiments of the present invention relate to an automatic merchandiser system is explained as a preferred embodiment which states that if the at least one user has a pair of eyeglasses that he/she desires to convert to sunglasses then he/she goes to the automatic merchandiser system, which is like a free-standing cabinet similar to an ATM. The display on the screen of the automatic merchandiser system wherein, the display is a touch screen display shows examples of product or promotional art until interacted with the at least one user. The at least one user herein is then directed to the menu of the options that he/she may purchase for example; lens covers, stickers, decals or other product made from an adhesive film. Once the product selection has been made the at least one user is then enabled to choose a material from a variety of materials and patterns to select the type of product the at least one user wants. Then the at least one user is prompted to pay, wherein the payment is made either via bill valuator that is enabled to receive a cash payment or via a card reader which is enabled to receive a card payment. In the case of a lens cover or other product to be applied to a custom form provided by the user, the automatic merchandiser system unlocks the receiving bay to a 3D scanner and the at least one user is prompted to place the glasses on the marker in the 3D scanner and close the lid. The 3D scanner scans the glasses to determine the dimensions to cut from the material selected. The automatic merchandiser system cuts the material from a spool of stocked material by use of a plotter, which is fed the dimensions from the scan performed. The custom cut material is dropped into the delivery box and the at least one user is prompted to take their glasses and product. A receipt is then printed. Instructions on how to apply the product is also provided by printed material or on screen. Additionally, the automatic merchandiser also vends stickers, screen protectors and/or decals. The automatic merchandiser system is also enabled to be connected to the internet allowing the at least one user to download content to be turned into stickers or decals.

Potentially the automatic merchandiser system would be enabled with image editing software allowing the at least one user to turn a photo or other digital image into a high contrast image consisting of a positive and negative value that can be cut into a sticker. The automatic merchandiser system is enabled to stock protective film for screen protectors. The automatic merchandiser system similarly scan the screen size of a given object to produce the desired adhesive film for a screen cover. Other materials used herein may be polarized films, colored films, transparent, translucent or opaque, or perforated films. The internet connectivity also allows the operator of the automatic merchandiser system to track sales data, supplies, and other important data for the management of the machine. The rolls of material could be replaced periodically and cycled by the manager of the equipment with new or different content to enable different products to be produced by the machine on demand.

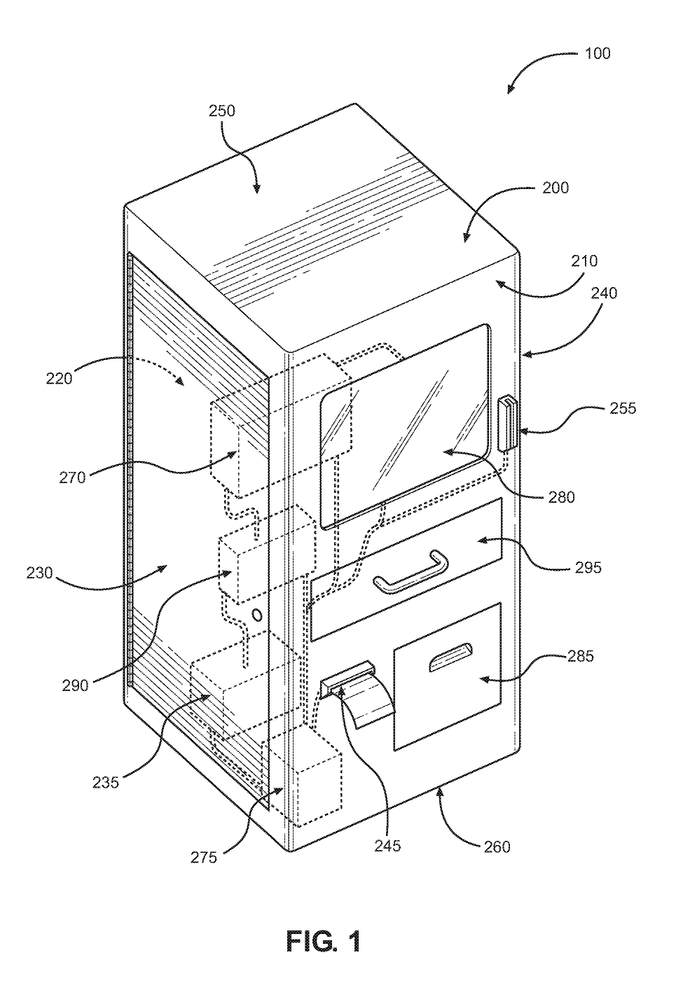

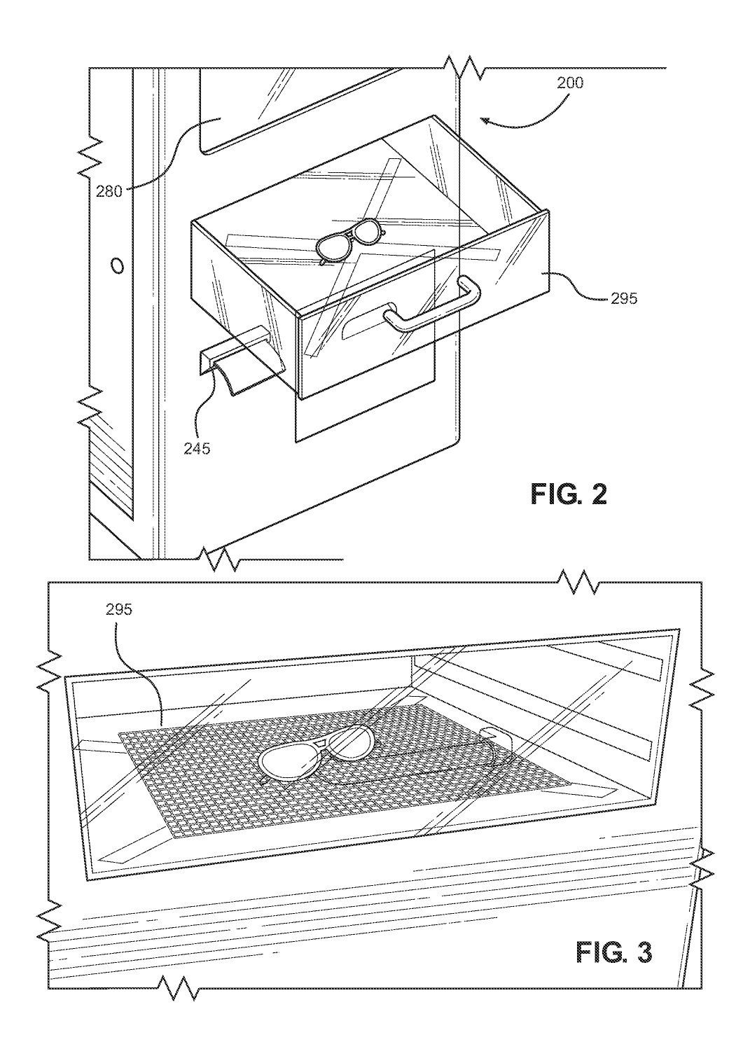

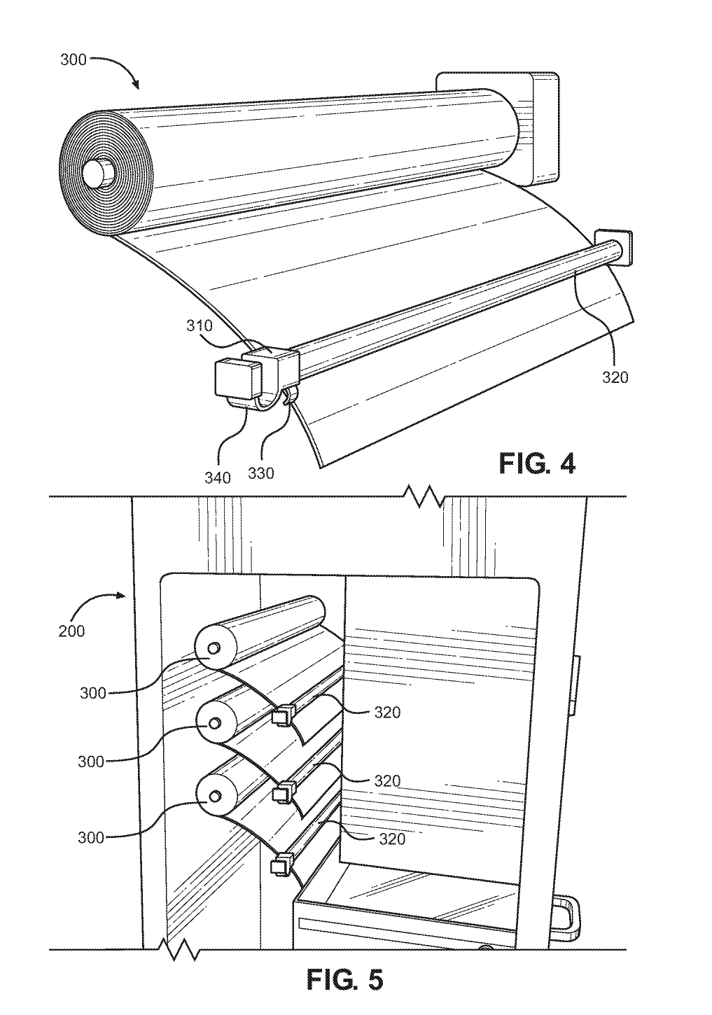

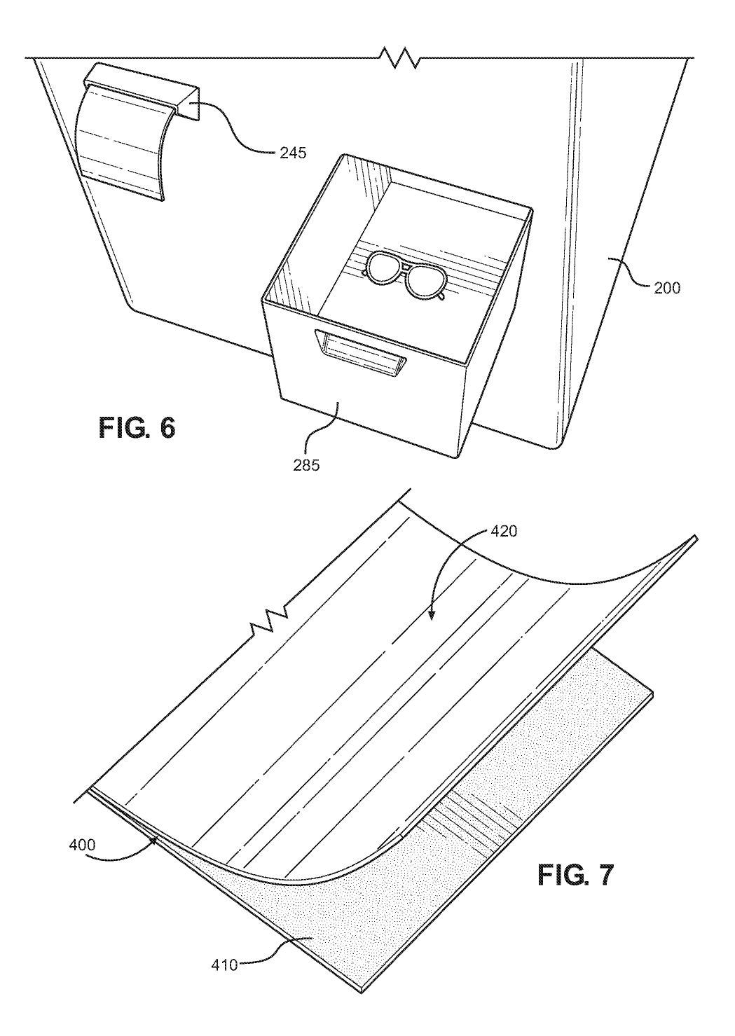

Referring to the drawings by numerals of reference there is shown in FIGS. 1-7 a preferred embodiment of the automatic merchandiser system 100 comprising a cabinet member 200 including a front panel 210, a back panel 220, two side panels (230 and 240) that are spaced and connected respectively to the front and back panels, a top panel 250 connected to top portions of the front, back, and side panels, and a bottom panel 260 connected to bottom portions of the front, back, and side panels, wherein the front panel, the back panel, the two side panels, the top panel, and the bottom panel form an interior volume; a computer module 270 including computer software applications, wherein the computer module is located within the interior volume, a display screen 280, located on the front panel and is electronically connected to said computer module, wherein the display screen may formed as a liquid crystal diode screen including touch screen capabilities; a scanner member 290 located within the interior volume of the cabinet member, is electronically connected to the computer module, and is adapted to scan objects in three dimensions and send scanned image information to the computer module; a scanning drawer 295 removably located within the interior volume of the cabinet member in proximity to the scanner member and is adapted to receive a product from a user to be scanned by the scanner member; at least one spool of stocked material 300 located within the interior volume; at least one cutting member 310 including at least one support member 320 connected to the two side panels of the cabinet member and located within the interior volume; at least one cutting blade 330 movably connected to the at least one support member; a motor member 340 electronically connected to the computer module, is connected to the at least one support member, and is adapted to move the at least one cutting blade; a product receiving compartment 285 movably attached to the cabinet member, is adapted to be removably located within the interior volume, is adapted to receive a portion of stock material after the stock material is cut by the at least one cutting member, and is adapted to allow a user to retrieve the cut stock material; a power source 275 located within the interior volume of the cabinet member, is electrically connected to the computer module, the display screen, the scanner member, and the motor member of each of the at least one cutting member, and is adapted to supply power thereto, wherein the automatic merchandiser system is adapted such that a user can place merchandise within the scanning drawer, select at least one spool of stocked material via the display screen, have the scanner member scan the merchandise, have the computer module and the at least one cutting member cut material from selected ones of the at least one spool of stocked material in accordance with scanned image information of the merchandise, and make available the cut stock material within said receiving compartment for a user to retrieve.

The automatic merchandiser system may further comprise a card reader member 255 located on the front panel, be electronically connected to the computer module and the power source, and be adapted to retrieve and process payment information from a payment card for services rendered by the automatic merchandiser system; a receipt printer member 245 located on the front panel, be electronically connected to the computer module and the power source, and be adapted to print out a receipt for services rendered by the automatic merchandiser system; and a transceiver member 235 located within the interior volume of the cabinet member, be electronically connected to the computer module, and be adapted to transmit and send electronic signals remotely via radio waves. The radio waves may be transmitted and received via an internet system.

The computer software applications of said computer module can be adapted to track sales data, amounts of stocked material, and other important data for the management of said automatic merchandiser system. The computer software applications may also be adapted to provide a user with remote diagnosing capabilities to remotely monitor said automatic merchandiser system and schedule necessary software upgrades and repairs. Furthermore, the computer software applications can be adapted to allow a user to input photographic and digital images via said transceiver into said computer module and convert them into high contrast images consisting of positive and negative values that can be used by said computer module for cutting respective said stock material in desired shapes and styles, and to cut images into the surface of said stock material.

As shown in FIG. 5, the preferred embodiment may include three spools of stocked material 300, wherein each of the three spools of stocked material are formed having different material properties; and wherein there are three cutting members 330 each adapted to cut a respective one of the three spools of stocked material.

As shown in FIG. 7, the stocked material may be formed from a protective film 400 adapted to protect the merchandise and may consist of polarized films, colored films, opaque films, and perforated films. The protective film may also include an adhesive material 410 on one side thereof adapted to adhere to a surface of said merchandise. The protective film may also include a removable backing material 420 adapted to removably cover the adhesive material, such that after being cut by the cutting member and retrieved by the user the backing material is peeled off exposing the adhesive material for attaching to the merchandise.

It should be noted that the steps described in the method of use can be carried out in many different orders according to user preference. The use of “step of” should not be interpreted as “step for”, in the claims herein and is not intended to invoke the provisions of 35 U.S.C. § 112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An automatic merchandiser system comprising:
a cabinet member including:
a front panel;
a back panel;
two side panels;
wherein said two side panels; are spaced and connected respectively to said front and back panels;
a top panel;
wherein said top panel is connected to top portions of said front, back, and side panels; and
a bottom panel;
wherein said bottom panel is connected to bottom portions of said front, back, and side panels;
wherein said front panel, said back panel, said two side panels, said top panel, and said bottom panel form an interior volume;
a computer module including:
computer software applications;
wherein said computer module is located within said interior volume;
a display screen;
wherein said display screen is located on said front panel and is electronically connected to said computer module;
a scanner member;
wherein said scanner member is located within said interior volume of said cabinet member, is electronically connected to said computer module, and is adapted to scan objects in three dimensions and send scanned image information to said computer module;
a scanning drawer;
wherein said scanning drawer is removably located within said interior volume of said cabinet member in proximity to said scanner member and is adapted to receive a product from a user to be scanned by said scanner member;
at least one spool of stocked material;
wherein said at least one spool of stocked material is located within said interior volume;
at least one cutting member including:
at least one support member;
wherein said at least one support member is connected to said two side panels of said cabinet member and located within said interior volume;
at least one cutting blade;
wherein said at least one cutting blade is movably connected to said at least one support member;
a motor member;
wherein said motor member is electronically connected to said computer module, is connected to said at least one support member, and is adapted to move said at least one cutting blade;
a product receiving compartment:
wherein said product receiving compartment is movably attached to said cabinet member, is adapted to be removably located within said interior volume, is adapted to receive a portion of stock material after said stock material is cut by said at least one cutting member, and is adapted to allow a user to retrieve said cut stock material;
a power source;
wherein said power source is located within said interior volume of said cabinet member, is electrically connected to said computer module, said display screen, said scanner member, and said motor member of each of said at least one cutting member, and is adapted to supply power thereto;
wherein said automatic merchandiser system is adapted such that a user can place merchandise within said scanning drawer, select at least one spool of stocked material via said display screen, have said scanner member scan said merchandise, have said computer module and said at least one cutting member cut material from selected ones of said at least one spool of stocked material in accordance with scanned image information of said merchandise, and make available said cut stock material within said receiving compartment for a user to retrieve.

2. The automatic merchandiser system of claim 1, wherein said stocked material is formed from a protective film adapted to protect said merchandise.

3. The automatic merchandiser system of claim 2, wherein said protective film is chosen from a list of protective films consisting of polarized films, colored films, opaque films, and perforated films.

4. The automatic merchandiser system of claim 1, further comprising a card reader member located on said front panel, is electronically connected to said computer module and said power source, and is adapted to retrieve and process payment information from a payment card for services rendered by said automatic merchandiser system.

5. The automatic merchandiser system of claim 1, further comprising a receipt printer member located on said front panel, is electronically connected to said computer module and said power source, and is adapted to print out a receipt for services rendered by said automatic merchandiser system.

6. The automatic merchandiser system of claim 1, further comprising a transceiver member located within said interior volume of said cabinet member, is electronically connected to said computer module, and is adapted to transmit and send electronic signals remotely via radio waves.

7. The automatic merchandiser system of claim 6, wherein said radio waves are transmit and received via an internet system.

8. The automatic merchandiser system of claim 1, wherein said computer software applications of said computer module are adapted to track sales data, amounts of stocked material, and other important data for the management of said automatic merchandiser system.

9. The automatic merchandiser system of claim 3, wherein said protective film includes an adhesive material on one side thereof adapted to adhere to a surface of said merchandise.

10. The automatic merchandiser system of claim 9, wherein said protective film includes a removable backing material adapted to removably cover said adhesive material, such that after being cut by said cutting member and retrieved by said user said backing material is peeled off exposing said adhesive material for attaching to said merchandise.

11. The automatic merchandiser system of claim 7, wherein said computer software applications of said computer module are adapted to provide a user with remote diagnosing capabilities to remotely monitor said automatic merchandiser system and schedule necessary software upgrades and repairs.

12. The automatic merchandiser system of claim 1, wherein there are three spools of stocked material; wherein each of said three spools of stocked material are formed having different material properties; and wherein there are three cutting members each adapted to cut a respective one of said three spools of stocked material.

13. The automatic merchandiser system of claim 12, wherein each said stocked material is formed from a protective film adapted to protect said merchandise; and wherein each said protective film is chosen from a list of protective films consisting of polarized films, colored films, opaque films, and perforated films.

14. The automatic merchandiser system of claim 1, wherein said display screen is formed as a liquid crystal diode screen including touch screen capabilities.

15. The automatic merchandiser system of claim 6, wherein said computer software applications of said computer module include image editing software adapted to allow a user to input photographic and digital images via said transceiver into said computer module and convert them into high contrast images consisting of positive and negative values that can be used by said computer module for cutting respective said stock material in desired shapes and styles, and to cut images into the surface of said stock material.
